(19) United States
(12) Patent Application Publication
(10) Pub. No.: US 2010/0065664 A1
(43) Pub. Date: Mar. 18, 2010

(54) DOSING DEVICE

(76) Inventor: Frank Miller, Ilsfeld (DE)

Correspondence Address: KENYON & KENYON LLP, ONE BROADWAY, NEW YORK, NY, 10004, US

(21) Appl. No.: 12/305,567

(22) PCT Filed: Dec. 12, 2007
(86) PCT No.: PCT/EP2007/063756

§ 371 Date: Nov. 30, 2009

(30) Foreign Application Priority Data
Jan. 31, 2007 (DE) 102007004799.3

(51) Int. Cl. F02M 63/00

(52) U.S. Cl. 239/533.2

(57) ABSTRACT

The invention relates to a dosing device for liquid fuels, in particular for the supply into a chemical reformer to obtain hydrogen, or into a postcombustion device to produce heat. The dosing device has at least one metering device to meter fuel into a metering line, and a conditioning unit, which abuts the metering line and delivers the fuel into a metering chamber. The conditioning unit is designed as a purely mechanical valve, which opens and closes at a frequency of approximately 1500 Hz.

### FIELD OF INVENTION

The present invention relates to a dosing device.

### BACKGROUND INFORMATION

Transport systems based on fuel cells use what is known as chemical reformers to obtain the required hydrogen from hydrocarbon-containing fuels such as gasoline, ethanol or methanol, for instance. Catalytic burners and postcombustion devices are used to generate heat, in particular in cold-start phases.

All of the substances needed by the reformer for the course of reaction, such as air, water and fuel, are ideally supplied to the reaction region in the gaseous or at least atomized state. However, since the fuels, such as methanol or gasoline and water, are preferably stored onboard the transportation system in liquid form, they must be conditioned just before reaching the reaction region of the reformer. This requires, for example, a dosing device which is able to provide the corresponding quantities of fuel or other materials in finely atomized form.

So-called catalytic burners or postcombustion devices provide the temperature required for the chemical reaction, in which the fuel among other things is reformed to hydrogen, for example. Catalytic burners are components featuring surfaces coated with a catalyst. In these catalytic burners the fuel/air mixture is converted into heat and exhaust gases, the generated heat being conducted to the appropriate components such as the chemical reformer or an evaporator via the lateral surfaces and/or via the warm exhaust-gas stream, for example.

The conversion of fuel into heat is highly dependent upon the size of the fuel droplets striking the catalytic layer. The smaller the size of the droplets and the more uniformly the catalytic layer is wetted with the fuel droplets, the more completely the fuel is converted into heat and the higher the efficiency. Furthermore, the fuel is also converted more rapidly and the pollutant emissions are reduced. Fuel droplets that are too large in size result in coating of the catalytic layer and hence, in a slow conversion rate. This leads to, e.g., poor efficiency, especially in the cold start phase.

Since the hydrogen is mostly used immediately, chemical reformers have to be in a position to adjust the production of hydrogen to the demand, without delay, e.g. in load changes or launching phases. Especially in the cold start phase, additional measures must be taken, since the reformer does not provide any waste heat. Conventional evaporators are not capable of generating adequate quantities of gaseous reactants without delay.

Therefore, it is practical to distribute the fuel in well-conditioned form with the aid of a metering device in finely-atomized manner and/or placed advantageously in locations and areas where the fuels can evaporate well, such as in the reaction chamber or the premixing chamber of a reformer or catalytic burner, the interior surfaces of a cylindrical combustion chamber, or the interior surface areas of a catalytic burner. Furthermore, it is useful to be able to adapt the fuel cloud in its geometric form, its propagation rate and swirl formation, to the combustion chamber and to the conditions prevailing therein.

German Patent Application No. DE 102 51 697 A1 describes a dosing device for liquid fuels, in particular for feeding into a chemical reformer to obtain hydrogen, or into a postcombustion device to produce heat. The dosing device has at least one metering device in the form of a fuel injector to meter fuel into a metering line, and a nozzle body adjoining the metering line, which nozzle body has at least one spray-discharge orifice that discharges into a metering chamber. Downstream from the flow, a support element is mounted on the nozzle body of the dosing device, which includes a component having the spray-discharge orifices, as well as a swirl insert disposed upstream.

A dosing device for liquid fuels, in particular for feeding into a chemical reformer to obtain hydrogen, or into a postcombustion device to produce heat is also described in German Patent Application No. DE 102 51 699 A1. The dosing device has at least one metering device in the form of a fuel injector to meter fuel into a metering line, and a nozzle body adjoining the metering line, which nozzle body has at least one spray-discharge orifice that discharges into a metering chamber. The nozzle body of the dosing device is designed in such a way that a disk-shaped apertured spray insert is provided there, in which the at least one spray-discharge orifice is formed.

### SUMMARY OF THE INVENTION

In contrast, the dosing device according to the present invention, has an advantage that it considerably improves the atomization and distribution of the fuel or the fuel-gas mixture. More specifically, the dosing device may be used without difficulty in especially high ambient temperatures. It is therefore possible to use the dosing device in fuel cells (catalytic converters), in the exhaust gas aftertreatment, or in the regeneration of particulate filters because temperatures of up to 700° C. are reached in these applications, which the dosing device is advantageously able to withstand. The dosing device according to the present invention can be produced in a very simple, reliable and thus cost-effective manner. Furthermore, it is possible to use standardized, serial-production components. In particular, the purely mechanical valve used as conditioning unit has a very simple design and is thus able to be integrated into the dosing device in an especially uncomplicated manner.

In an advantageous manner, the metering line and the metering device are joined with the aid of an adapter in a hydraulically tight and detachable manner. This increases the ease of assembly.

In one additional further development, the adapter connecting the metering line and the metering device includes an air supply, which is connected to the metering line inside the adapter. This makes it possible to already initiate the carburetion in the metering line, the fuel metered into the metering line and/or the metered gas being mixed with air. The atomization and mixture formation of fuel and/or the metered gas with air is thereby improved overall. Furthermore, undesired fuel and gas residue is able to be removed from the metering line with the aid of the air supply in that, for example, air is blown through the air supply during a stopping or idling phase, for instance. An uncontrolled delivery of fuel into the metering chamber or the environment can be prevented in this manner.

Advantageously used as dosing device is a fuel injector as it is utilized, for example, for reciprocating internal combustion engines having internal combustion. The use of such injectors has several advantages. For example, they allow particularly accurate fuel metering, the metering being controllable on the basis of several parameters such as the on-off ratio, the pulse frequency and possibly the length of travel. In this context, the dependence on the pumping pressure is considerably less pronounced than in metering devices that regulate the volume flow of the fuel via the line cross section, and the metering range is considerably greater.

Moreover, the fuel injectors are reliable components that have proven effective, are known in terms of their behavior and are inexpensive and chemically stable vis-à-vis the fuels used; this is true especially of so-called low-pressure fuel injectors, which may be used in this instance because of the thermal decoupling by the metering line.

The metering line advantageously has a number of sections that have reduced wall thickness, which lower the thermal conductivity of the metering line or which may also function as cooling body.

Because of the multi-part design of the dosing device, it is possible to produce it cost-effectively and to use standardized components.

### BRIEF DESCRIPTION OF THE DRAWINGS

FIG. 1 shows a schematic representation of an exemplary embodiment of a dosing device according to the present invention.

FIG. 2 shows a representation of a conditioning unit at the downstream end of the dosing device.

### DETAILED DESCRIPTION

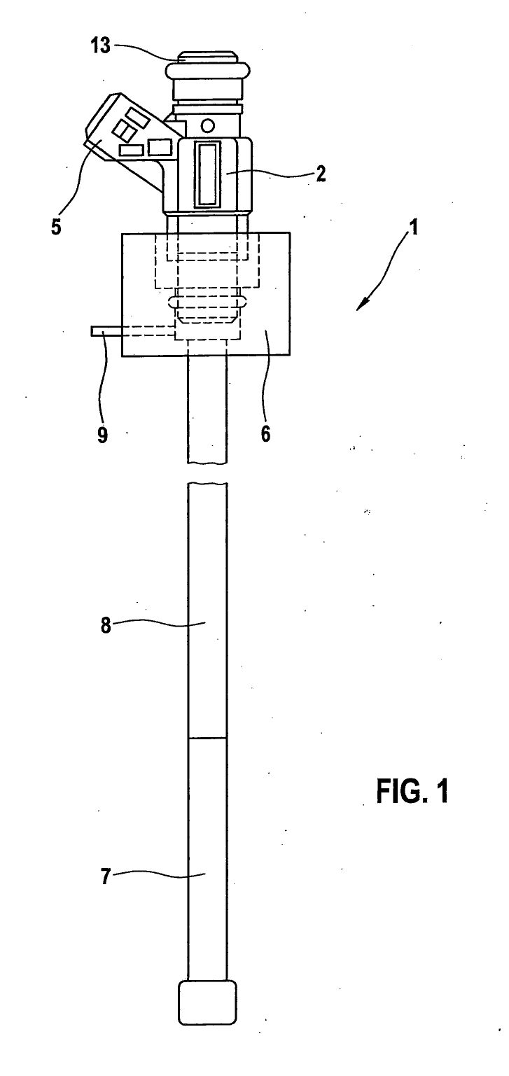

An exemplary embodiment, shown in FIG. 1, of a dosing device 1 according to the present invention is developed in the form of a dosing device 1 for the use of low pressure fuel injectors. Dosing device 1 is particularly suitable for the delivery and atomization of fuel or a fuel-gas mixture into a metering chamber (not shown) of a not further depicted chemical reformer to obtain hydrogen, or into a not further depicted postcombustion device to produce heat. Basically, however, such a dosing device 1 is especially suited for metering fuel into hot environments. While known fuel injectors are designed for the dosing of media such as gasoline, diesel fuel, ethanol, methanol, urea-water solutions, etc., for ambient temperatures of approximately 150° C., dosing device 1 according to the present invention may not only be utilized for the already mentioned applications in connection with fuel cells, but also for the exhaust-gas aftertreatment or the regeneration of particulate filters, since temperatures of up to roughly 700° C. are reached in these applications, which dosing device 1 is advantageously able to withstand.

Dosing device 1 is made up of a metering device 2, which is designed as low-pressure fuel injector in this exemplary embodiment, an adapter 6 to accommodate metering device 2, and a tubular metering line 8 having a length of approximately 10 to 100 cm, for example, an air supply 9, which may optionally be provided on adapter 6, and a conditioning unit 7. Metering device 2 has the classic fuel injector design and includes a fuel connection 13 on its inflow side. To excite the actuator, which is operated electromagnetically, for example, metering device 2 has been provided with an electric connection 5. The metering of fuel or a fuel-gas mixture into metering line 8 takes place at the downstream end of dosing device 2, adapter 6 connecting dosing device 2 and metering line 8 to one another in a manner that provides hydraulic sealing with respect to the outside. Air supply 9 terminates inside adapter 6 and thus is connected to metering line 8.

Conditioning unit 7 is connected to metering line 8 in hydraulically sealing manner. Metering line 8 itself consists of, for example, a standardized metal pipe made of stainless steel. Metering line 8 may have one or two parts; if metering line 8 consists of multiple parts, then hydraulically sealing connection elements are used.

When dosing device 1 is in operation, fuel is flowing through dosing device 2 and is metered into metering line 8 in the conventional manner by opening and closing a sealing seat. Air supply 9, which terminates in metering line 8 via adapter 6, makes it possible to supply air or other gases, e.g., combustible residual gases from a reforming or fuel-cell process, for the carburetion. In the further course, the fuel or the fuel-gas mixture flows through metering line 8 to carburetion unit 7, from where it is metered into a metering chamber (not illustrated). Air for the controlled evacuation of metering line 8 can also be supplied through air supply 9, for instance shortly before an idling or stopping phase.

Because of metering line 8, dosing device 2, and in particular the sealing seat (not shown) of dosing device 2, which is sensitive to high temperatures and great temperature fluctuations, is thermally decoupled from the temperatures in the metering chamber (not shown), which may reach 500° C., for example. The length, material and form of metering line 8 are selected specifically in accordance with the temperature and space situations. It is preferred if metering line 8 also has sections where the wall thickness is reduced, which contribute to the thermal insulation or which can function as cooling bodies.

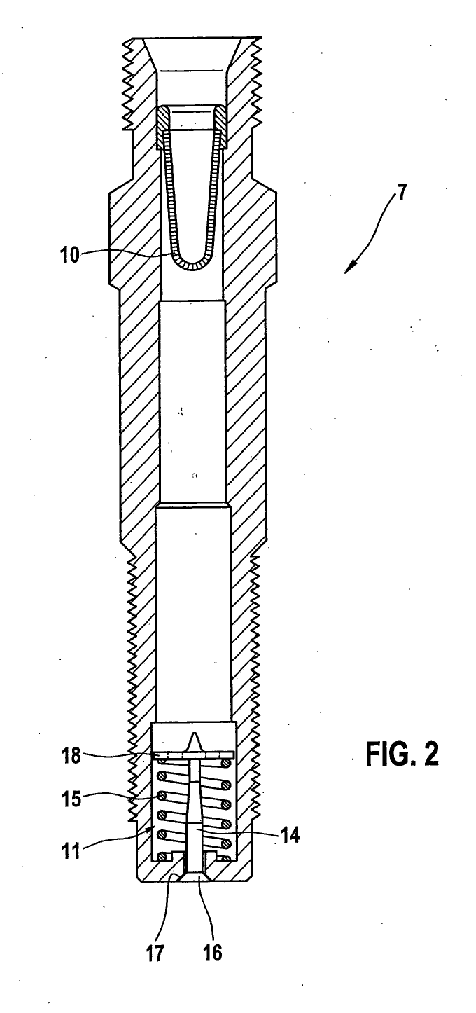

FIG. 2 shows an enlarged view of conditioning unit 7, which is provided at the downstream end of dosing device 1. Conditioning unit 7 is designed as purely mechanical valve 11. Optionally, a filter sieve 10 may be installed in conditioning unit 7. The downstream end of conditioning unit 7 is formed by the actual valve 11, which includes a valve stud 14 and a restoring spring 15. At its upstream end, valve stud 14 has a collar device 18, which may be supported on restoring spring 15, while a valve head 16 is provided at the downstream end of valve stud 14. Valve head 16 of valve stud 14 cooperates with a frustoconical valve seat 17 to form a sealing seat. Since mechanical valve 11 is an outwardly opening valve, in the nonpressurized state of conditioning unit 7, valve head 16 rests against valve seat 17 due to the spring force of restoring spring 15.

Valve 11 opens automatically, e.g., at an overpressure of approximately 3.6 bar, and has no metering function, which metering device 2 is already assuming. Valve 11 opens and closes at a frequency of approximately 1500 Hz, which is why it is also possible to speak of “chatter” of valve 11, and induces excellent carburetion and atomization of the fuel, which is delivered in sprays having the finest droplets. The atomization quality is improved further by the possible air support.

To reduce the thermal loading of conditioning unit 7, conditioning 7 may additionally be placed inside a receptacle provided with cooling fins.

1-11. (canceled)

12. A dosing device for delivery of liquid fuels into one of a chemical reformer, a postcombustion device for generation of heat, an exhaust tract, and a particulate filter, comprising:
at least one metering device configured to meter fuel into a metering line; and
a conditioning unit adjoining the metering line, configured to deliver the fuel into a metering chamber,
wherein the conditioning unit is a purely mechanical valve.

13. The dosing device according to claim 12, wherein the valve is configured as an outwardly opening valve.

14. The dosing device according to claim 12, wherein the valve includes a valve stud and a restoring spring.

15. The dosing device according to claim 14, wherein the valve stud includes a collar device, on which the restoring spring is supported.

16. The dosing device according to claim 14, wherein the valve stud includes a valve head, which cooperates with a valve seat.

17. The dosing device according to claim 12, wherein the valve opens and closes at a frequency of approximately 1500 Hz.

18. The dosing device according to claim 12, further comprising:
a filter sieve installed in the conditioning unit.

19. The dosing device according to claim 12, further comprising:
a receptacle provided with cooling fins into which the conditioning unit is configured to be introduced.

20. The dosing device according to claim 12, further comprising:
an adapter configured to join the metering line and the metering device in hydraulically sealing and detachable manner.

21. The dosing device according to claim 20, wherein the adapter includes an air supply connected to the metering line inside the adapter.

22. The dosing device according to claim 12, wherein the metering device is a fuel injector.
